(19) United States
(12) Patent Application Publication
(10) Pub. No.: US 2024/0286560 A1
(43) Pub. Date: Aug. 29, 2024

(54) AUTOMOBILE SIGN PLATE WITH MULTI-LEVEL COLORFUL EFFECT

(71) Applicant: Jiangsu Kaizhi Technology Co., Ltd., Zhenjiang (CN)

(72) Inventor: Yu YAO, Zhenjiang (CN)

(73) Assignee: Jiangsu Kaizhi Technology Co., Ltd., Zhenjiang (CN)

(21) Appl. No.: 18/483,773

(22) Filed: Oct. 10, 2023

(30) Foreign Application Priority Data
Feb. 26, 2023 (CN) 202320313661.4

(51) Int. Cl. B60R 13/00

(52) U.S. Cl. CPC B60R 13/005

(57) ABSTRACT

An automobile sign plate includes a substrate, where a colorful film for generating colorful light and shadow is laid on the substrate; a plurality of refraction portions for generating colorful patterns are arranged on the colorful film; an outer side of the substrate is surrounded by a highlight mirror surface chamfer portion; the top of the highlight mirror surface chamfer portion exceeds a surface, where the colorful film is laid, of the substrate. The highlight mirror surface chamfer portion will reflect natural light to be rendered as a halo of light and shadow outside the colorful light and shadow generated by the colorful film.

### CROSS-REFERENCE TO RELATED APPLICATIONS

This application claims priority to Chinese Patent Application No. 202320313661.4, filed on Feb. 26, 2023, the content of which is incorporated herein by reference in its entirety.

### TECHNICAL FIELD

The present disclosure relates to the technical field of automobile sign plates, and in particular to an automobile sign plate with a multi-level colorful effect.

### BACKGROUND

Existing automobile sign plates usually only have a simple function of identifying the brand and single shape. With the increasing demand of automobile consumers for automobile appearance and interior decoration, the existing automobile sign plates cannot meet the requirements of the consumers. At present, some vehicles also use LED lights to light the automobile sign plates, but using the light-emitting diode (LED) lights to light the automobile sign plates involves the control of light brightness and color, so that the energy consumption of the whole vehicle is increased, the structure is complicated, and the cost is high. Therefore, more colorful automobile sign plates with higher visual effect and lower cost are selected for the existing automobile sign plates. The colorful automobile sign plates can make the automobile sign plates have colorful light and shadow effect, but in the prior art, the colorful automobile sign plates have a single level of the colorful effect; furthermore, due to the flaw on the colorful edge, the whole visual effect is flawed.

### SUMMARY

An objective of the present disclosure is to provide an automobile sign plate with a multi-level colorful effect for the defects in the prior art, so that the fact that the overall effect is not beautiful due to gaps on colorful edges is avoided while the colorful effect level of the colorful automobile sign plate is richer.

To achieve the above objective, the present disclosure adopts the following technical solution.

An automobile sign plate with a multi-level colorful effect includes a substrate, where a colorful film for generating colorful light and shadow is laid on the substrate; a plurality of refraction portions for generating colorful patterns are arranged on the colorful film; an outer side of the substrate is surrounded by a highlight mirror surface chamfer portion; the top of the highlight mirror surface chamfer portion exceeds a surface, where the colorful film is laid, of the substrate.

Further, the exceeding top part of the highlight mirror surface chamfer portion surrounds the area, where the colorful film is located, of the substrate to form a shielding groove portion; the shielding groove portion shields a laying gap between the colorful film and the surface of the substrate to enhance the light and shadow effect by the highlight mirror surface chamfer portion and the refraction portions; and the shielding groove portion shields the laying gap between the colorful film and the surface of the substrate, so that the aesthetic degree is improved.

Further, the shapes of the refraction portions are linear or curved for generating linear or sinuous colorful light and shadow patterns.

Further, the refraction portions are refraction grooves, and a groove width of each of the refraction grooves is nano-scale.

Further, the automobile sign plate further includes a light and shadow enhancement film, where the light and shadow enhancement film is laid above or below the colorful film.

Further, a height of each of the shielding groove portions is set to be 0.05-1 mm for shielding light and shadow at a certain angle of a side view angle.

Further, an angle of the highlight mirror surface chamfer portion is set to be between 30 degrees and 50 degrees for better rendering the light and shadow of the main body.

Further, an auxiliary mounting mechanism is arranged on a back side of the substrate and is used for the mounting of the sign plate.

Further, the shielding groove portion is a highlight mirror surface.

Further, the refraction portions may be directly placed on the substrate.

Further, the refraction portions may be stacked in multiple layers.

The following beneficial effects can be achieved by the technical solution of the present disclosure.

By the following structure: a substrate is included; a colorful film for generating colorful light and shadow is laid on the substrate; a plurality of refraction portions for generating colorful patterns are arranged on the colorful film; an outer side of the substrate is surrounded by a highlight mirror surface chamfer portion; the top of the highlight mirror surface chamfer portion exceeds a surface, where the colorful film is laid, of the substrate; the exceeding top part of the highlight mirror surface chamfer portion surrounds the area, where the colorful film is located, of the substrate to form the shielding groove portion; and the shielding groove portion shields the laying gap between the colorful film and the surface of the substrate, the fact that the overall effect is not beautiful due to gaps on colorful edges is avoided while the colorful effect level of the colorful automobile sign plate is richer.

### BRIEF DESCRIPTION OF THE DRAWINGS

To describe the technical solutions in the embodiments of the present disclosure or in related art more clearly, the accompanying drawings required for describing the embodiments or the related art are briefly described below. Apparently, the accompanying drawings in the following description only show some embodiments recorded in the present disclosure, and a person of ordinary skill in the art may still derive other drawings from these accompanying drawings without creative efforts.

FIG. 1 is a front view of an automobile sign plate with a multi-level colorful effect according to an embodiment of the present disclosure.

FIG. 2 is a schematic diagram of an automobile sign plate with a multi-level colorful effect according to an embodiment of the present disclosure.

FIG. 3 is a partially enlarged diagram of FIG. 2 according to an embodiment of the present disclosure.

FIG. 4 is a schematic right-side view of an automobile sign plate with a multi-level colorful effect according to an embodiment of the present disclosure.

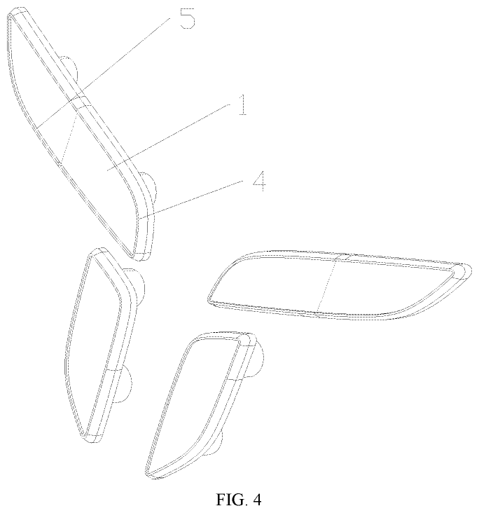

FIG. 5 is a schematic left-lower-side view of an automobile sign plate with a multi-level colorful effect according to an embodiment of the present disclosure.

FIG. 6 is a front view of a back side of an automobile sign plate with a multi-level colorful effect according to an embodiment of the present disclosure.

FIG. 7 is a stereoscopic schematic diagram of a back side of an automobile sign plate with a multi-level colorful effect according to an embodiment of the present disclosure.

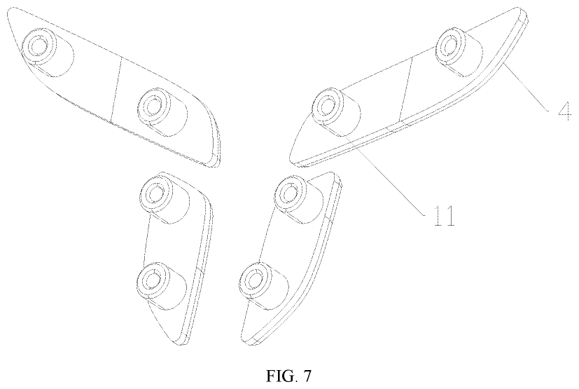

FIG. 8 is a section view of an automobile sign plate with a multi-level colorful effect according to an embodiment of the present disclosure.

FIG. 9 is a schematic diagram of a refraction portion according to an embodiment of the present disclosure.

### DETAILED DESCRIPTION OF THE EMBODIMENTS

The technical solutions in the embodiments of the present disclosure are clearly and completely described below in conjunction with the accompanying drawings in the embodiments of the present disclosure. Apparently, the embodiments described are only a part rather than all of the embodiments of the present disclosure.

In the description of the present disclosure, it should be noted that orientations or position relationships indicated by terms “center”, “top”, “bottom”, “left”, “right”, “vertical”, “horizontal”, etc. are orientation or position relationships as shown in the drawings, and these terms are just used to facilitate description of the present disclosure and simplify the description, but not to indicate or imply that the mentioned device or elements must have a specific orientation and must be established and operated in a specific orientation, and thus, these terms cannot be understood as a limitation to the present disclosure.

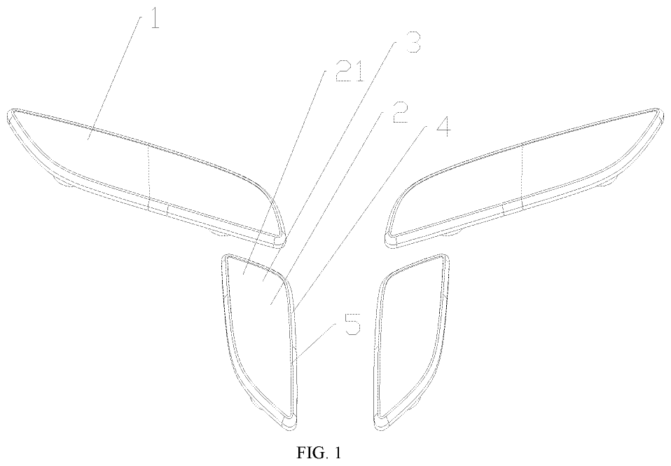

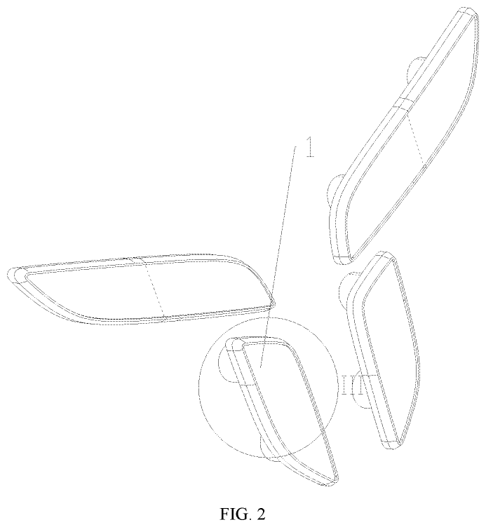

An automobile sign plate with a multi-level colorful effect, as shown in FIG. 1 and FIG. 2, includes a substrate 1, where a colorful film 2 for generating colorful light and shadow is laid on the substrate 1; a plurality of refraction portions 21 for generating colorful patterns are arranged on the colorful film 2; an outer side of the substrate 1 is surrounded by a highlight mirror surface chamfer portion 4; the top of the highlight mirror surface chamfer portion 4 exceeds a surface, where the colorful film 2 is laid, of the substrate 1. The exceeding top part of the highlight mirror surface chamfer portion 4 surrounds the area, where the colorful film 2 is located, of the substrate 1 to form a shielding groove portion 5; the shielding groove portion 5 shields a laying gap between the colorful film 2 and the surface of the substrate 1.

Specifically, by the following structure: the colorful film 2 for generating colorful light and shadow is laid on the substrate 1, and the plurality of refraction portions 21 for generating colorful patterns are arranged on the colorful film 2, so that colorful light and shadow can be generated by the colorful film 2; and the plurality of refraction portions 21 are arranged on the colorful film 2, so that the colorful light and shadow can show different patterns. By the following structure: the outer side of the substrate 1 is surrounded by the highlight mirror surface chamfer portion 4 and the top of the highlight mirror surface chamfer portion 4 exceeds the surface, where the colorful film 2 is laid, of the substrate 1, during use of the sign plate, the highlight mirror surface chamfer portion 4 will reflect natural light to be rendered as a halo of light and shadow outside the colorful light and shadow generated by the colorful film 2; the halo of light and shadow reflected by the highlight mirror surface chamfer portion 4 is derived from natural light, so that the colorful light and shadow generated by the colorful film 2 and different patterns presented by the refraction portions 21 are displayed more naturally, and the display level of the whole light and shadow is richer and more harmonious. By the following structure: the exceeding top part of the highlight mirror surface chamfer portion 4 surrounds the area, where the colorful film 2 is located, of the substrate 1 to form the shielding groove portion 5, and the shielding groove portion 5 shields a laying gap between the colorful film 2 and the surface of the substrate 1, the laying gap between the colorful film and the surface of the substrate is covered, and the aesthetic degree of the sign plate is improved; and the reflection angle of the colorful film 2 to the periphery is shielded by the shielding groove portion 5 to a certain degree, so that when the sign plate is observed from the side, the rendering part of the highlight mirror surface chamfer portion 4 will be larger than the front observation effect, and the light and shadow effect of the colorful film 2 is smaller than the front observation effect, which will change along with the change of the observation angle, so that the multi-angle observation effect level of the sign plate is richer.

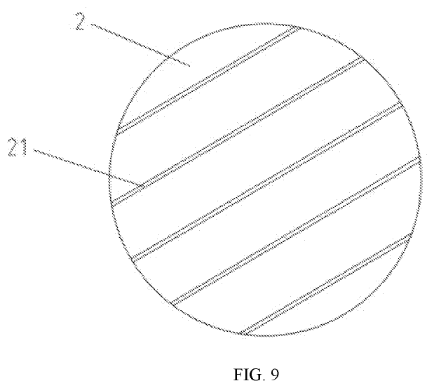

As a preference of the above embodiment, as shown in FIG. 9, the shapes of the refraction portions 21 are linear or curved.

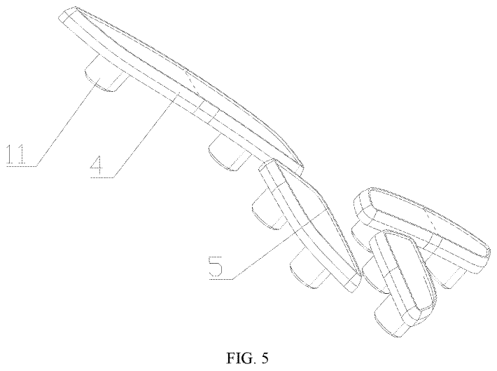

Specifically, by the structure that the shapes of the refraction portions 21 are linear or curved, if the refraction portions 21 are linear, linear colorful light and shadow patterns can be generated around the refraction portions 21. As shown in FIG. 5, if the refraction portions 21 are curved, sinuous curved colorful light and shadow patterns can be generated around the refraction portions 21, and the shapes of the refraction portions 21 can be customized according to requirements of customers.

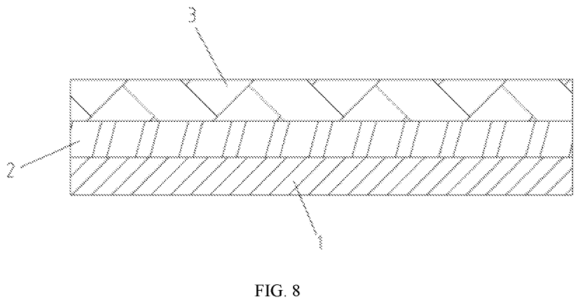

As a preference of the above embodiment, as shown in FIG. 8, the refraction portions 21 are refraction grooves.

Specifically, the refraction portions 21 are the refraction grooves, and a groove width of each of the refraction grooves is nano-scale for better achieve the refraction effect.

As a preference of the above embodiment, as shown in FIG. 8, the automobile sign plate further includes a light and shadow enhancement film 3, and the light and shadow enhancement film 3 is laid above or below the colorful film 2.

Specifically, the light and shadow enhancement film 3 is made of a colorful transparent resin material, so that one layer of colorful color can be increased on the basis of the colorful light and shadow, and the colorful effect is more beautiful.

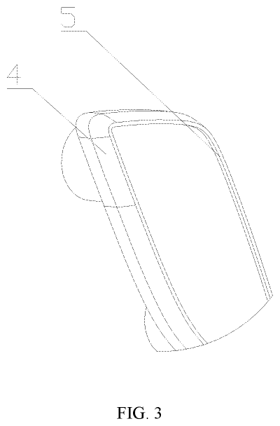

As a preference of the above embodiment, as shown in FIG. 3, a height of the shielding groove portion 5 is set to be 0.05-1 mm.

As a preference of the above embodiment, as shown in FIG. 3, an angle of the highlight mirror surface chamfer portion 4 is set to be between 30 degrees and 50 degrees, preferably, 45 degrees.

Specifically, by the following structure: the height of the shielding groove portion 5 is set to be 0.05-1 mm and the angle of the highlight mirror surface chamfer portion 4 is set to be between 30 degrees and 50 degrees, under the condition that the shielding groove portion 5 covers the laying gap between the colorful film and the surface of the substrate, the multi-angle observation effect level of the sign plate is enriched through the change of the light and shadow, and the highlight mirror surface chamfer portion 4 can better set off the rendering effect around the light and shadow of the main body.

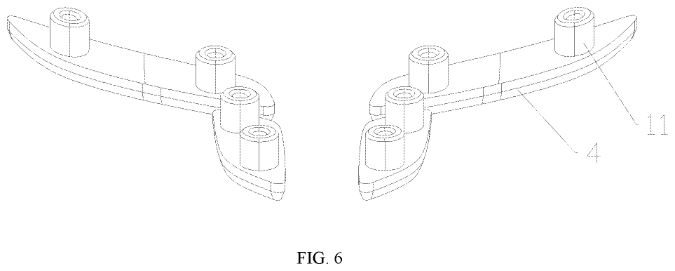

As a preference of the above embodiment, as shown in FIG. 6, an auxiliary mounting mechanism 11 is arranged on a back side of the substrate 1.

As a preference of the above embodiment, as shown in FIG. 3, the shielding groove portion 5 is a highlight mirror surface.

Specifically, by the structure that the shielding groove portion 5 is the highlight mirror surface, when the sign plate with the strong light and shadowing prominent effect is required, the shielding groove portion 5 may be set as the highlight mirror surface, and the edge of the colorful light and shadow is reflected for many times from the front side, so that a more complicated light and shadow effect is achieved.

As a preference of the above embodiment, as shown in FIG. 3, the refraction portions 21 may be directly placed on the substrate 1.

As a preference of the above embodiment, as shown in FIG. 3, the refraction portions 21 may be stacked in multiple layers.

Specifically, by the following structure: the substrate is included; the colorful film for generating colorful light and shadow is laid on the substrate; a plurality of refraction portions for generating colorful patterns are arranged on the colorful film; an outer side of the substrate is surrounded by a highlight mirror surface chamfer portion; the top of the highlight mirror surface chamfer portion exceeds a surface, where the colorful film is laid, of the substrate; the exceeding top part of the highlight mirror surface chamfer portion surrounds the area, where the colorful film is located, of the substrate to form the shielding groove portion; and the shielding groove portion shields the laying gap between the colorful film and the surface of the substrate, the problems in the prior art that the colorful effect of the automobile sign plate is not rich and the overall effect is not beautiful due to the gaps on the colorful edges are solved.

The automobile sign plate of the present disclosure may further be applied to a rim or the exterior decoration of the rim, and the exterior decoration of other parts, so that the overall light and shadow display level of the part is richer and more harmonious.

The above displays and describes the basic principles, the main features and the advantages of the present disclosure. It should be understood by those skilled in the art that, the present disclosure is not limited by the above embodiments. The above embodiments and the description only illustrate the principle of the present disclosure. Various changes and modifications may be made to the present disclosure without departing from the spirit and scope of the present disclosure. Such changes and modifications all fall within the claimed scope of the present disclosure. The protection scope of the present disclosure is defined by the appended claims and their equivalents.

What is claimed is:

1. An automobile sign plate with a multi-level colorful effect, comprising a substrate; wherein
a colorful film for generating colorful light and shadow is laid on the substrate;
a plurality of refraction portions for generating colorful patterns are arranged on the colorful film;
an outer side of the substrate is surrounded by a highlight mirror surface chamfer portion; and
a top of the highlight mirror surface chamfer portion exceeds a surface, where the colorful film is laid, of the substrate.

2. The automobile sign plate with a multi-level colorful effect according to claim 1, wherein an exceeding top part of the highlight mirror surface chamfer portion surrounds an area, where the colorful film is located, of the substrate to form a shielding groove portion; a shielding groove portion shields a laying gap between the colorful film and the surface of the substrate.

3. The automobile sign plate with a multi-level colorful effect according to claim 1, wherein a shape of each of the plurality of refraction portions is linear or curved.

4. The automobile sign plate with a multi-level colorful effect according to claim 1, wherein the plurality of refraction portions are refraction grooves.

5. The automobile sign plate with a multi-level colorful effect according to claim 1, further comprising a light and shadow enhancement film, wherein the light and shadow enhancement film is laid above or below the colorful film.

6. The automobile sign plate with a multi-level colorful effect according to claim 2, wherein a height of each of the shielding groove portions is set to be 0.05-1 mm.

7. The automobile sign plate with a multi-level colorful effect according to claim 1, wherein an angle of the highlight mirror surface chamfer portion is set to be between 30 degrees and 50 degrees.

8. The automobile sign plate with a multi-level colorful effect according to claim 1, wherein an auxiliary mounting mechanism is arranged on a back side of the substrate.

9. The automobile sign plate with a multi-level colorful effect according to claim 1, wherein the shielding groove portion is a highlight mirror surface.

10. The automobile sign plate with a multi-level colorful effect according to claim 1, wherein the plurality of refraction portions are capable of being directly placed on the substrate.

11. The automobile sign plate with a multi-level colorful effect according to claim 1, wherein the plurality of refraction portions are capable of being stacked in multiple layers.
